(19) United States
(12) Patent Application Publication
(10) Pub. No.: US 2006/0032325 A1
(43) Pub. Date: Feb. 16, 2006

(54) Automatic transmission engaged in manual transmission

(76) Inventor: Jung Ho Baek, Pusan (KR)

Correspondence Address: Mayer Fortkort & Williams, 251 North Avenue West, 2nd Floor, Westfield, NJ, 07090, US

(21) Appl. No.: 10/535,384

(22) PCT Filed: Nov. 18, 2003
(86) PCT No.: PCT/KR03/02484

§ 371 Date: May 17, 2005

(30) Foreign Application Priority Data
Jan. 27, 2003 (KR) 10-2003-0006640

(51) Int. Cl. G05G 9/00

(52) U.S. Cl. 74/473.1

(57) ABSTRACT

The present invention relates to an automatic transmission engaged in a manual transmission in which a gear change is automatically performed based on a speed of a vehicle, and an operation is easy, and it is possible to exchange a manual transmission with an automatic transmission by improving the construction of the manual transmission without exchanging the same.

### TECHNICAL FIELD

The present invention relates to a transmission for a vehicle, and in particular to an automatic transmission engaged in a manual transmission that is capable of automatically changing an engagement of gears based on the current running state of a vehicle in a manual transmission.

### BACKGROUND ART

Generally, a driving force transfer apparatus for a vehicle is directed to an apparatus capable of transferring a driving force generated in an engine to driving wheels. There are provided a clutch installed in a flywheel of an engine and intermitting a driving force transfer when a vehicle starts or during a speed change, a transmission adapted to change an engagement of gears based on a running state and adapted for a forward and backward movement, a drive pinion capable of decreasing a rotation speed of the transmission and transferring a driving force at a certain rotation speed proper to left and right driving wheels when a vehicle runs, a differential apparatus and a propeller shaft.

The transmission is installed between the clutch and the propeller shaft and is adapted to change a rotation of engine properly to a running state of a vehicle for thereby increasing a rotational force or changing to a high-speed rotation. In addition, the transmission is capable of maintaining an idle state of an engine or implementing a backward movement of a vehicle.

The transmission for a vehicle is classified into a manual transmission (MTM) in which a driver manually changes a speed of vehicle, and an automatic transmission (ATM) in which a speed change of vehicle is automatically performed based on a running state. In an operation method of the same, there are a direct operation method having a speed change lever in a transmission, and an indirect operation method in which a speed change lever and a transmission are distanced, and a link or wire are connected between the speed change lever and the transmission for thereby implementing an indirect operation method.

The automatic transmission is expensive, and a fuel consumption amount is high. In the manual transmission, it is difficult to operate for a beginner. When a driver drives for a long time, the driver easily feels tired.

Exchanging the manual transmission with the automatic transmission needs a high cost.

### DISCLOSURE OF INVENTION

Accordingly, it is an object of the present invention to provide an automatic transmission engaged in a manual transmission that overcomes the problems encountered in a conventional art.

It is another object of the present invention to provide an automatic transmission engaged in a manual transmission in which a speed change of gears is automatically performed based on a speed of a vehicle. It is easy to operate and is economical.

It is still another object of the present invention to provide an automatic transmission engaged in a manual transmission that may be changed to an automatic transmission by improving a manual transmission without exchanging the same.

To achieve the above objects, in an automatic transmission engaged in a manual transmission for operating a selector lever and a shift lever installed in a control shaft of a manual transmission, there is provided an automatic transmission engaged in a manual transmission that is characterized in that a motor 18 is installed in a post 19 of both sides fixed to a transmission, and a first shaft 10 and a second shaft 10a having a forward movement guide groove 12 and a backward movement guide groove 14 are provided in the motor 18, and feeders 20 and 20a each having a connection pin 22 having a rectangular hole 24 are assembled in such a manner that the feeders 20 and 20a are linearly moved along the forward and backward movement guide grooves when the first and second shafts are rotated, and the feeder 20 assembled to the first shaft 1 is connected with the fixing pin 1a of the selector lever, and the feeder 20a assembled to the second shaft is connected with the fixing pin 3a of the shift lever 3.

### BRIEF DESCRIPTION OF DRAWINGS

The present invention will become better understood with reference to the accompanying drawings which are given only by way of illustration and thus are not limitative of the present invention, wherein;

FIG. 1 is a disassembled perspective view illustrating an automatic transmission engaged in a manual transmission according to the present invention;

FIG. 2 is a cross sectional view illustrating an automatic transmission engaged in a manual transmission according to the present invention; and

FIG. 3 is a cross sectional view illustrating an automatic transmission engaged in a manual transmission according to the present invention.

### BEST MODE FOR CARRYING OUT THE INVENTION

The preferred embodiments of the present invention will be described with reference to the accompanying drawings.

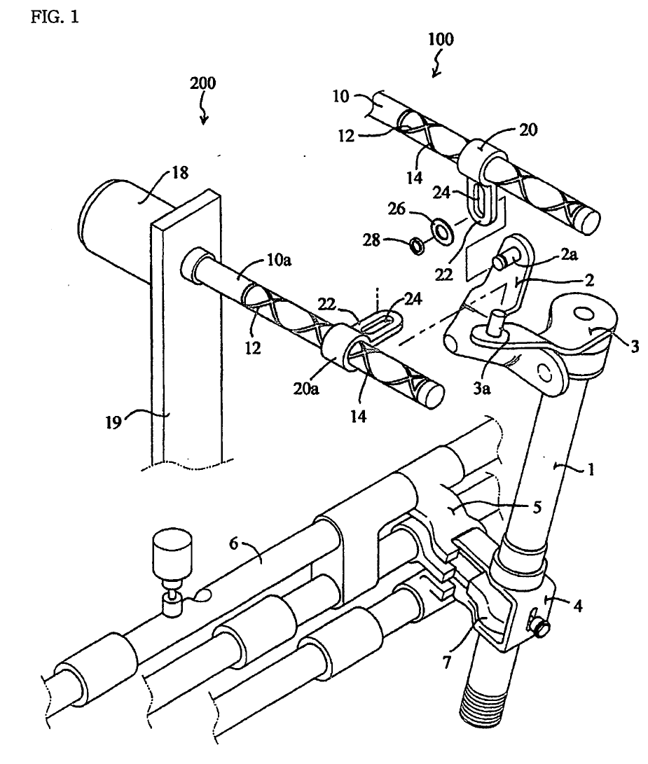

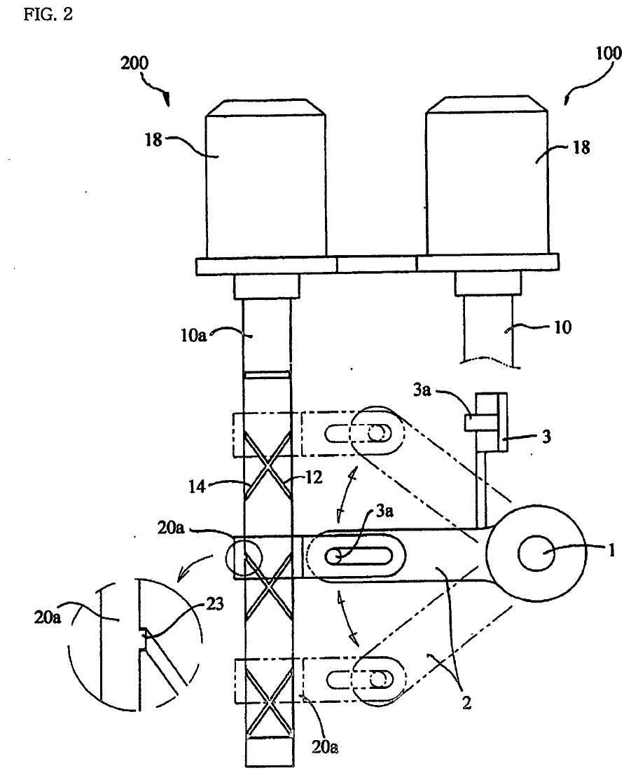

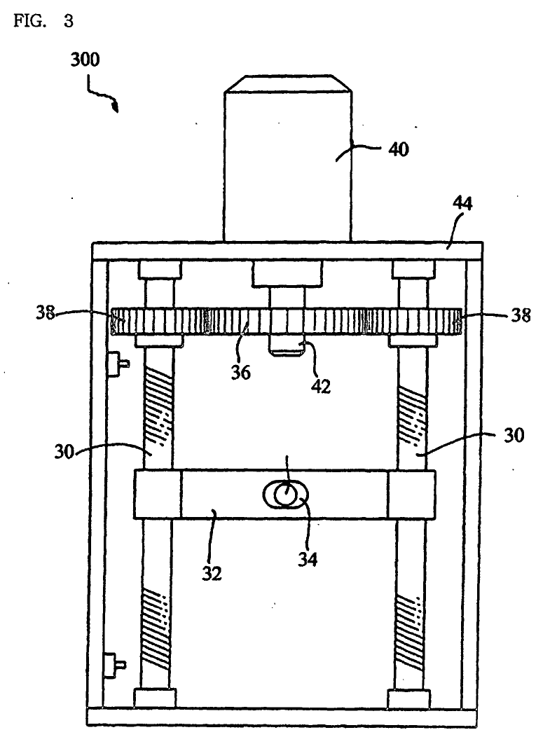

FIG. 1 is a disassembled perspective view illustrating an automatic transmission engaged in a manual transmission according to the present invention, FIG. 2 is a cross sectional view illustrating an automatic transmission engaged in a manual transmission according to the present invention, and FIG. 3 is a cross sectional view illustrating an automatic transmission engaged in a manual transmission according to the present invention.

As shown therein, there are provided an interlock plate 4 capable of preventing a double engagement of gears in the interior of a transmission, a control finger 7 installed in an inner side of the interlock plate, a shift rug engaged with the control finger, and a shift rail 6 to which the shift rug is fixed. The control shaft 1 assembled to the interlock plate is exposed to the outside of a housing (not shown) of the transmission.

In addition, in an outer end portion of the control shaft, there are provided a selector lever 2 for upwardly and downwardly moving the control shaft, and a shift lever 3 for rotating the control finger.

The present invention provided an operation apparatus capable of automatically operating the selector lever 2 and the shift lever 2, not using a speed change lever and a cable.

A certain post 19 is installed in the housing of the transmission near the control shaft 1. A motor 18 is installed at both sides based on the post. There are provided a first shaft 10 and a second shaft 10a in parallel as a rotary shaft of the motor. At this time, a spiral forward movement guide groove 12 and a backward movement guide groove 14 are formed in the first haft 10 and the second shaft 10a, respectively. Feeders 20 and 20a each having a protrusion 23 in an inner side are inserted into the first and second shafts, respectively. The above protrusion is forwardly and backwardly moved along the forward and backward movement guide grooves 12 and 14. A connection piece 22 is attached to an outer side of the feeders 20 and 20a, respectively. A rectangular hole 24 is formed in the center of the connection piece 22.

The feeder 20 assembled to the first shaft 10 is assembled with the selector lever 2 of the control shaft. When the first shaft is rotated based on a driving force of the motor, the selector lever 2 is driven, and the control shaft is vertically moved. With the above construction and operation, a selector lever operation apparatus 100 is implemented. The feeder 20a assembled to the second shaft 10a is assembled with the shift lever 3. When the second shaft is rotated based on a driving force of the motor, the control shaft is rotted based on the shift lever. With the above construction and operation, a shift lever operation apparatus 200 is implemented.

The rectangular hole 24 is formed in each feeder 20, 20a, so that fixing pins 2a and 3a provided in the selector lever 2 and the shift lever 3 are movable. Namely, the fixing pins 2a and 3a inserted into the rectangular hole 24 and fixed by a certain washer 26 or a snap ring or a bolt are vertically and horizontally movable along the rectangular hole. Therefore, it is possible to maintain a distance in which the center distance is moved when the selector lever 2 and the shift lever 3 are rotated.

The motor 18 of the selector lever operation apparatus 100 and the shift lever operation apparatus 200 is connected in such a manner that the motor receives a power from a battery of the vehicle. There is provided a controller (not shown) for operating the selector lever operation apparatus and the shift lever operation apparatus based on a speed of a vehicle.

As shown in FIG. 3, a clutch operation apparatus 300 is installed in the clutch together with the selector lever operation apparatus 100 and the shift lever operation apparatus 200 for thereby operating the clutch.

In the clutch operation apparatus 300, a motor 40 is installed in one side of the frame 44 fixed to the clutch, and a first gear 36 is assembled to the rotary shaft 42 of the motor. A spiral shaft 30 is installed at both sides of the first gear in parallel. A second gear 38 is engaged with the first gear 36. A hole 34 is formed in the center of the feeder 32 that is linearly moved as the spiral shaft 30 is rotated. A clutch lever 8 is inserted into the above hole. Therefore, as the feeder 32 is forwardly and backwardly moved, the clutch lever 8 is operated for thereby intermitting the rotational force of the engine. Sensors 46 and 47 are provided in the frame at the forward and backward movement positions of the feeder 32 for thereby detecting the position of the feeder and implementing a change at the accurate position.

The operation of the automatic transmission engaged in a manual transmission according to the present invention will be described.

First, when the speed of the vehicle is increased or decreased using an acceleration pedal, the controller transmits an electrical signal of a speed change state proper to the increased and decreased speed is transmitted to each operation apparatus, so that each motor is driven, and the lever is moved.

Namely, as the first shaft 10 is rotated, the feeder is moved, and the selector lever 2 is rotated. The control finger 7 selects the shift rug 5 of the level 5-backward or level 3-level 4 or level 1-level 2. The second shaft is rotated, and the control shaft is rotated based on the shift lever 3. The control finger moves the shift rug 5 in the directions of the levels 1, 3, 5 or intermediate position and levels 2, 4 and backward position. Since the shift rug is fixed to the shift rail 6 together with a shift pork, the shift pork moves a synchronizer sleeve for thereby implementing a speed change.

As shown in FIG. 3, the clutch operation apparatus 300 is operated before the speed change is performed for thereby operating the clutch lever 8. When the engine is started or before the gear of the transmission is changed, the engine maintains an idle state, namely, the engine maintains a state that the is rotational force of the engine is disconnected.

### INDUSTRIAL APPLICABILITY

As described above, the automatic transmission engaged in the manual transmission according to the present invention is directed to implementing an operation of an automatic transmission based on a relatively simple structure. It is possible to implement a desired automatic transmission function in a manual transmission without exchanging the conventional manual transmission of a vehicle. A driving operation is easy, and it is possible to prevent an error operation for thereby decreasing an accident. In addition, the optimum speed change is maintained, and the unnecessary consumption of fuel is decreased.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. In an automatic transmission engaged in a manual transmission for operating a selector lever 2 and a shift lever 3 installed in a control shaft of a manual transmission, an automatic transmission engaged in a manual transmission that is characterized in that a motor 18 is installed in a post 19 of both sides fixed to a transmission, and a first shaft 10 and a second shaft 10a having a forward movement guide groove 12 and a backward movement guide groove 14 are provided in the motor 18, and feeders 20 and 20a each having a connection pin 22 having a rectangular hole 24 are assembled in such a manner that the feeders 20 and 20a are linearly moved along the forward and backward movement guide grooves when the first and second shafts are rotated, and the feeder 20 assembled to the first shaft 1 is connected with the fixing pin 1a of the selector lever, and the feeder 20a assembled to the second shaft is connected with the fixing pin 3a of the shift lever 3.

2. In an automatic transmission capable of operating a clutch lever of a clutch installed in a manual transmission, an automatic transmission engaged in a manual transmission that is characterized in that a spiral shaft 30 rotating based on a driving of a motor 40 is provided at both sides, and a feeder 32 assembled to the spiral shaft of both sides has a hole 34 in a center portion, and a clutch lever 8 is inserted into the hole, and a clutch is operated based on a linear movement of the feeder.
